(19) United States
(12) Patent Application Publication
(10) Pub. No.: US 2019/0388810 A1
(43) Pub. Date: Dec. 26, 2019

(54) EXPLOSION-PROOF FILTER CARTRIDGE

(71) Applicant: XIAMEN FILTERTECH INDUSTRIAL CORPORATION, Xiamen (CN)

(72) Inventors: QING-HUA LIU, Xiamen (CN); YU-TING HU, Xiamen (CN)

(21) Appl. No.: 16/447,682

(22) Filed: Jun. 20, 2019

(30) Foreign Application Priority Data
Jun. 22, 2018 (CN) 201820968112.X

(51) Int. Cl. B01D 35/14; B01D 35/30; B01D 27/08

(52) U.S. Cl. CPC B01D 35/14; B01D 27/08; B01D 35/30

(57) ABSTRACT

An explosion-proof filter cartridge, that includes: a filter bottle, a filter nozzle, a filter cartridge, and a plurality of elastic balloons. The filter nozzle is disposed on an upper end of the filter bottle, the filter cartridge is disposed in the filter bottle. The plurality of elastic balloons are disposed on an inner wall of the filter bottle. The distance between the two elastic balloons is less than a diameter of the elastic balloon. The plurality of elastic balloons are disposed and distributed evenly on the inner wall of the filter bottle, to prevent explosion of the filter bottle when water in the filter bottle is frozen to ice.

### BACKGROUND OF THE INVENTION

### Field of the Invention

The present invention relates to a filter cartridge, and in particular to an explosion-proof filter cartridge, that can be used in a water purification device.

### The Prior Arts

Presently on the market, explosion-proof device is not provided for a filter cartridge contained in a filter bottle. The problem for this is that, when water is frozen into ice under zero degree Celsius, due to the expanded volume of the ice in the filter bottle, the filter bottle will be burst into explosion, thus causing damage and safety hazards.

Therefore, presently, the design and performance of the filter cartridge is not quite satisfactory, and it leaves much room for improvements.

### SUMMARY OF THE INVENTION

In view of the problems and drawbacks of the prior art, the present invention provides an explosion-proof filter cartridge, that is novel in design, and easy to operate.

The present invention provides an explosion-proof filter cartridge, comprising: a filter bottle; a filter nozzle, a filter cartridge 30, and a plurality of elastic balloons. The filter nozzle is disposed on an upper end of the filter bottle, the filter cartridge is disposed in the filter bottle. The plurality of elastic balloons are disposed on an inner wall of the filter bottle.

In an aspect of the present invention, the plurality of elastic balloons 40 are disposed and distributed evenly on the inner wall of the filter bottle 10.

In another aspect of the present invention, the plurality of elastic balloons 40 are disposed into an array on the inner wall of the filter bottle 10.

In a further aspect of the present invention, a distance between the two elastic balloons 40 is less than a diameter of the elastic balloon 40.

Compared with the Prior Art, the explosion-proof filter cartridge of the present invention has the following advantages: firstly, since the plurality of elastic balloons are distributed on an inner wall of the filter bottle, so that when water is frozen into ice, the elastic balloons will be pressed by the ice into contraction, to increase the volume and space in the filter bottle. Secondly, the elastic balloons provide elasticity, to buffer the pressure of the expanded ice.

Further scope of the applicability of the present invention will become apparent from the detailed descriptions given hereinafter. However, it should be understood that the detailed descriptions and specific examples, while indicating preferred embodiments of the present invention, are given by way of illustration only, since various changes and modifications within the spirit and scope of the present invention will become apparent to those skilled in the art from the detailed descriptions.

### BRIEF DESCRIPTION OF THE DRAWINGS

The related drawings in connection with the detailed descriptions of the present invention to be made later are described briefly as follows, in which:

FIG. 1 is a schematic diagram of an explosion-proof filter cartridge according to the present invention;

FIG. 2 is a cross section view of an explosion-proof filter cartridge according to the present invention; and

FIG. 3 is a cross section view of a filter cartridge according to the Prior Art.

### DETAILED DESCRIPTION OF THE PREFERRED EMBODIMENT

The purpose, construction, features, functions and advantages of the present invention can be appreciated and understood more thoroughly through the following detailed descriptions with reference to the attached drawings.

In the following, an embodiment is used to describe the various details of the present invention. However, it does not mean that this embodiment represents all the embodiments of the present invention. Other embodiments can be envisaged by people familiar with this field, and thus they all fall into the scope of the present invention.

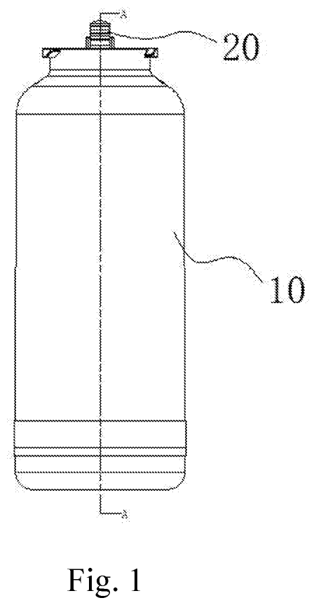

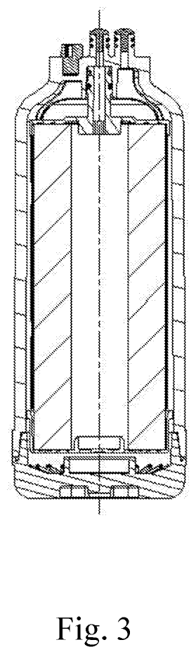

Refer to FIGS. 1-3 respectively for a schematic diagram of an explosion-proof filter cartridge according to the present invention; a cross section view of an explosion-proof filter cartridge according to the present invention; and a cross section view of a filter cartridge according to the Prior Art.

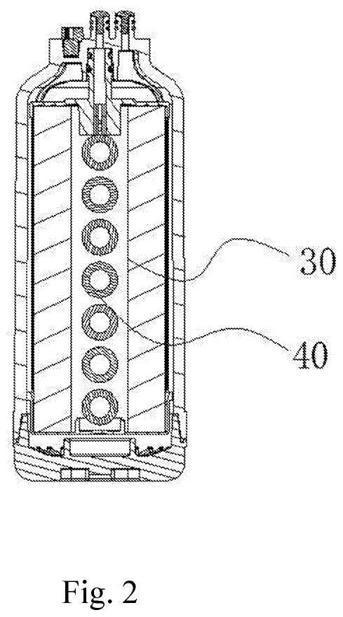

As shown in FIGS. 1-2, the present invention provides an explosion-proof filter cartridge, comprising: a filter bottle 10; a filter nozzle 20, a filter cartridge 30, and a plurality of elastic balloons 40. The filter nozzle 20 is disposed on an upper end of the filter bottle 10, the filter cartridge 30 is disposed in the filter bottle 10. The plurality of elastic balloons 40 are disposed on an inner wall of the filter bottle 10.

In an embodiment of the present invention, the disposition of the plurality of elastic balloons 40 could prevent explosion of a filter bottle 10. When the temperature of the water in the filter bottle 10 drops to below zero degrees Celsius, the water in the filter bottle 10 is frozen into ice, the volume of the ice is increased, to press the filter bottle 10. Further, the elastic balloons 40 tend to contract by the pressure of the ice, hereby increasing the volume and space in the filter bottle to a certain extent. Further, at the same time, the pressed elastic balloons 40 will produce an elastic force, to buffer the pressure of the ice, thus averting the explosion of the filter bottle 10.

In an embodiment of the present invention, the plurality of elastic balloons 40 are disposed evenly on the inner wall of the filter bottle 10. As such, the pressure exerted on the filter bottle 10 is made to distribute evenly, to reduce the possibility of explosion.

In an embodiment of the present invention, the plurality of elastic balloons 40 are disposed into an array on the inner wall of the filter bottle 10. As such, the pressure exerted on the filter bottle 10 is made to distribute evenly to prevent explosion, while giving a sense of aesthetics.

In an embodiment of the present invention, a distance between the two elastic balloons 40 is less than a diameter of the elastic balloon 40. Since the elastic balloons 40 are disposed into an array on the inner wall of the filter bottle 10, thus they could form into a string. With the plurality of elastic balloons 40 placed along the vertical direction, to cover the upper end and lower end of the filter bottle 10, while a distance between the two elastic balloons 40 is less than a diameter of the elastic balloon 40.

In operation, when the water in the filter bottle 10 is frozen into ice, the elastic balloons 40 is made to contract by the pressure exerted by the ice. When the ice in the filter bottle 10 is unfrozen into water, the elastic balloons 40 will restore to their original positions.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. An explosion-proof filter cartridge, comprising:
a filter bottle;
a filter nozzle, disposed on an upper end of the filter bottle;
a filter cartridge, disposed in the filter bottle; and
a plurality of elastic balloons, disposed on an inner wall of the filter bottle.

2. The explosion-proof filter cartridge as claimed in claim 1, wherein the plurality of elastic balloons are disposed and distributed evenly on the inner wall of the filter bottle.

3. The explosion-proof filter cartridge as claimed in claim 2, wherein the plurality of elastic balloons are disposed into an array on the inner wall of the filter bottle.

4. The explosion-proof filter cartridge as claimed in claim 3, wherein a distance between the two elastic balloons is less than a diameter of the elastic balloon.
